(19) United States
(12) Patent Application Publication
(10) Pub. No.: US 2015/0109766 A1
(43) Pub. Date: Apr. 23, 2015

(54) Tackle Boxes

(71) Applicants: Adam Gibbs, Westborough, MA (US); Nick Bongi, Westborough, MA (US)

(72) Inventors: Adam Gibbs, Westborough, MA (US); Nick Bongi, Westborough, MA (US)

(21) Appl. No.: 14/061,490

(22) Filed: Oct. 23, 2013

(51) Int. Cl. F21V 21/14; F21V 33/00; A01K 97/06

(52) U.S. Cl. CPC F21V 21/14; A01K 97/06; F21V 33/008
USPC 362/154; 43/17.5

(57) ABSTRACT

The invention is a lighted, three tray tackle box with a light that can be used for nighttime fishing.

### TECHNICAL FIELD

Nighttime fishing

### BACKGROUND ART

The design and consistency of a tackle box has varied over the years. Designs are constantly changing due to the steady demand of the fishing industry. Large tackle boxes can range from three trays, four trays, five trays, or even 6 trays. Smaller tackle boxes such as one tray boxes usually consist of a removable tray and a large storage compartment, along with a bottom housing storage compartment for larger fishing necessities.

Tackle boxes have been used for many years to house and store all necessary bait and tackle required for fishing. They are brought along with the fishermen so they can access any of their supplies when needed. Tackle boxes typically have a base and a lid, with a latch to open and close the box. When the lid is open, the user is able to pull out a collapsible three tray housing system that expands when access is needed , and collapses storage. The lid is attached to the base by a hinge that runs the length of the box allowing the lid to open and close. The box, when closed, has a handle at the top used for carrying the tackle box.

### SUMMARY OF INVENTION

### Technical Problem

Tackle boxes on the market are currently only used for daytime fishing lacking the ability to be used at night. Fishing is vastly enjoyed at night among thousands of fishermen worldwide. The fishermen cannot see the contents in the tackle box, and the surrounding area of the tackle box. This makes fishing at night less enjoyable. Typically, flashlights, headlamps, and other lighting necessities are used for nighttime fishing. This is a major inconvenience for the fisherman. It makes fishing difficult at night when the fishermen needs to locate their supplies, and see into their tackle boxes. Headlamps, flashlight, etc. are also additional tools to bring on a fishing trip, and take up more space on a boat, for example.

### Solution to Problem

Currently, a vast majority of fishermen fish at night due to the better fishing conditions. The tackle box is where the fishermen's necessary supplies are stored. A lighted tackle box with a detachable, self contained, rechargeable light emitting diode (LED) light would change the nighttime fishing industry. Fishermen would no longer need to bring a flashlight or headlamp fishing, for the tackle box will be able to be lighted. The fishermen will now be able to locate all of their supplies at night while not having to hold a secondary instrument such as a flashlight or headlamp.

When not being used in the daytime, the light that can be mounted on a set of hinges that adjust into various positions for preferred lighting, can be folded flat into the top tray (where the light is held) for daytime fishing. The light can also detach to be used as an underwater fish light, and light any preferred area by the fisherman. The light is a tubular LED light that is perfect for holding to light the beach, boat, etc. at night. When done using the light, it can be snapped back into the hinge on the tackle box for storage for continued use of lighting the tackle box. A simple on/off switch on the side of the box powers the light. To resupply the power of the light, disposable batteries are not needed. A simple charge of the internal rechargeable batteries restores the light's power in the matter of a few hours. It is a multiuse light that is perfect for any nighttime fishing.

### Advantageous Effects of Invention

The lighted tackle box is perfect for lighting the contents of the tackle box at night. It provides the lighting one will need to locate supplies in the tackle box. The light can also be removed from the hinge to be used as a tubular light for a variety of reasons. It can be used to light the beach to search for any hooks or to see fish. It can also be used to light the boat at night. The greatest advantage of all is its waterproofness. The light can be used as underwater fish light. This can attract fish to ones boat or dock making fishing incredible. The light has the ability to be completely immersed in water for the fisherman's desired use. When needed, the light is snapped back into the hinge of the tackle box that adjusts the light up and down. This lighted feature provides many advantages than other tackle boxes on the market. It provides the tackle box with light for nighttime fishing, and serves the purpose of a detachable rechargeable self contained led light used for an underwater fish light, and a powerful flashlight used for the boat, beach, etc.

### BRIEF DESCRIPTION OF THE TECHNICAL DRAWINGS

FIG. 1 is a perspective view of a light bracket according to the invention;

FIG. 2 is a plan rear view of the light bracket;

FIG. 3 is a bottom view of the light bracket;

FIG. 4 is a perspective view showing the light assembly folded into a tray;

FIG. 5 is a perspective view showing the light assembly in an upright position.

### DETAILED DESCRIPTION OF THE DRAWINGS

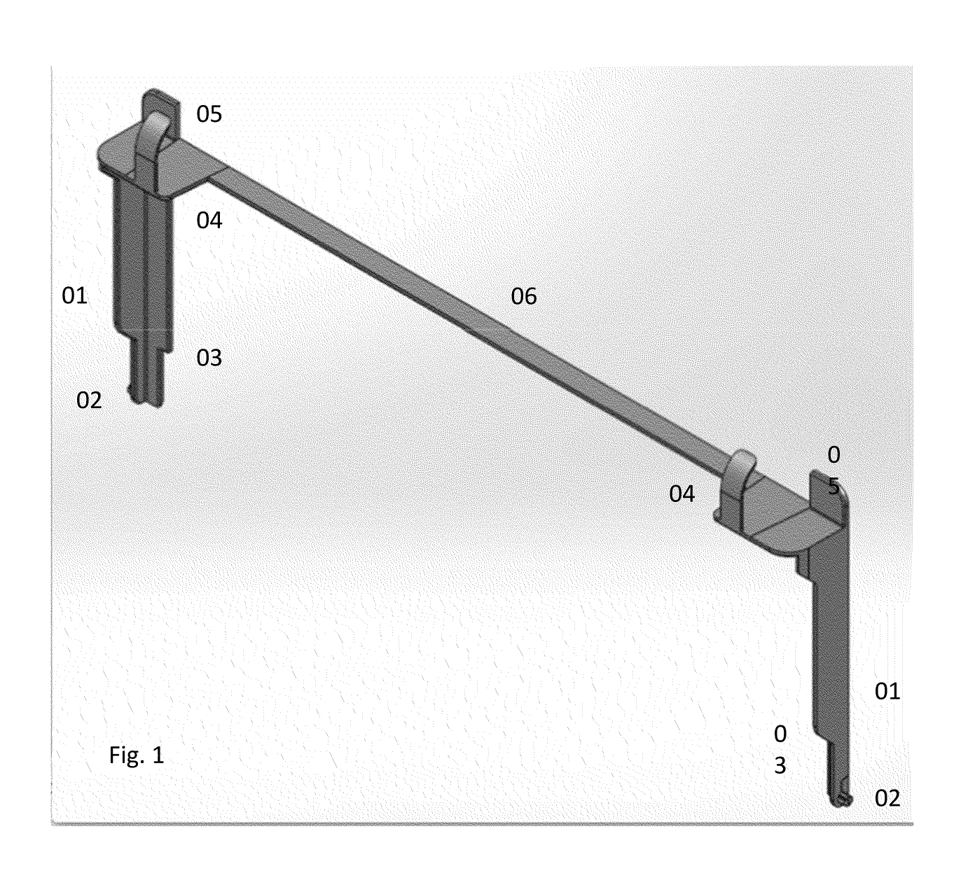

The invention is a lighted, three tray tackle used for nighttime fishing. The tackle box preferably has three trays that either fold up for desired use, or collapse for storage of the box 08. When the trays 08 are folded upward, the top tray 08 has a simple hinge system FIG. 1. The hinge system connects to the top tray at the front corners of the tray on either side. The hinge can be lifted up and down by pegs on either end of the hinge 02 that allows the hinge to adjust into various positions for preferred lighting.

At the top of the hinge, a claw system 04 is provided to hold the LED tubular, self contained, rechargeable light 07. This light connects (snap fits) into the claws of the hinge system when needed to light the tackle box. The light has an on/off switch on the side of the tube. The light has internal batteries that can be charged by the user. The hinge clicks into various positions based on the users lighting preference.

The light is able to light all three trays, and the bottom-housing compartment that is used for large fishing supplies. When the light is not in use in the nighttime, the hinge with the light can fold flat into the top of the top tray 12.

Based on user preference, the hinge system itself can be removed from the tackle box allowing the user to make use of the space for lures or tackle taken up by the hinge. For the nighttime, the hinge can be easily snapped back into the tray for preferred use 02. The light itself can be simply removed from the hinge system and can be used as a flashlight for a variety of reasons other than lighting a tackle box. The light detached from the hinge FIG. 1 can be used to light a dock, boat, beach, fish, etc. by the user. The light 07 is completely waterproof; therefore it can also be used as an underwater flashlight, or fish light. When lighting the tackle box, rain will not affect the light. When done, the light can be snapped back into the bracket FIG. 1, folded flat into the top tray 12, and the tackle box can be closed for simple and easy storage.

### FIG. 1: Light Bracket

01: Two opposing legs allowing the bracket to pivot and move into an upright position.
02: Pegs on either end, which connect the bracket into the tray.
03: Two opposing lips on either end of the legs, which allow the bracket to stop in an upright position.
04: Clips on either end of the bracket, which allow the light to snap into position and stay secure.
05: Two small plastic backings, which allow the light to remain secure.
06: Back support bar keeping the light secure and stable.

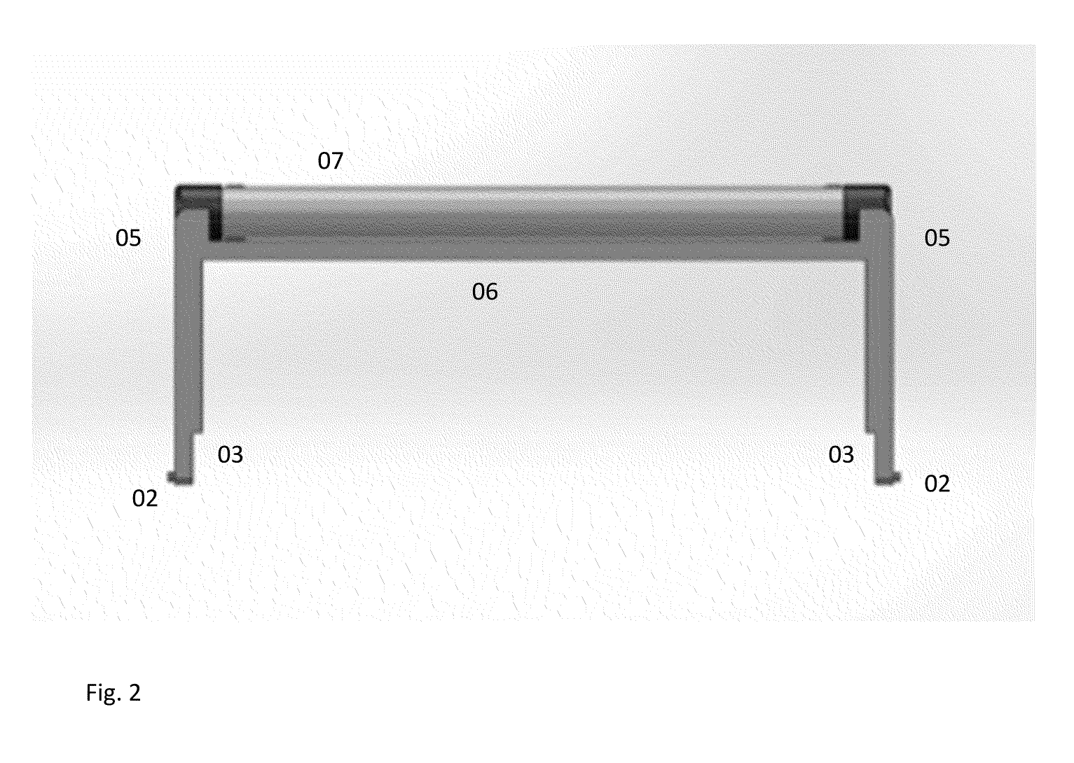

### FIG. 2: Rear View Light Bracket:

07: Tubular LED light connected into the bracket.

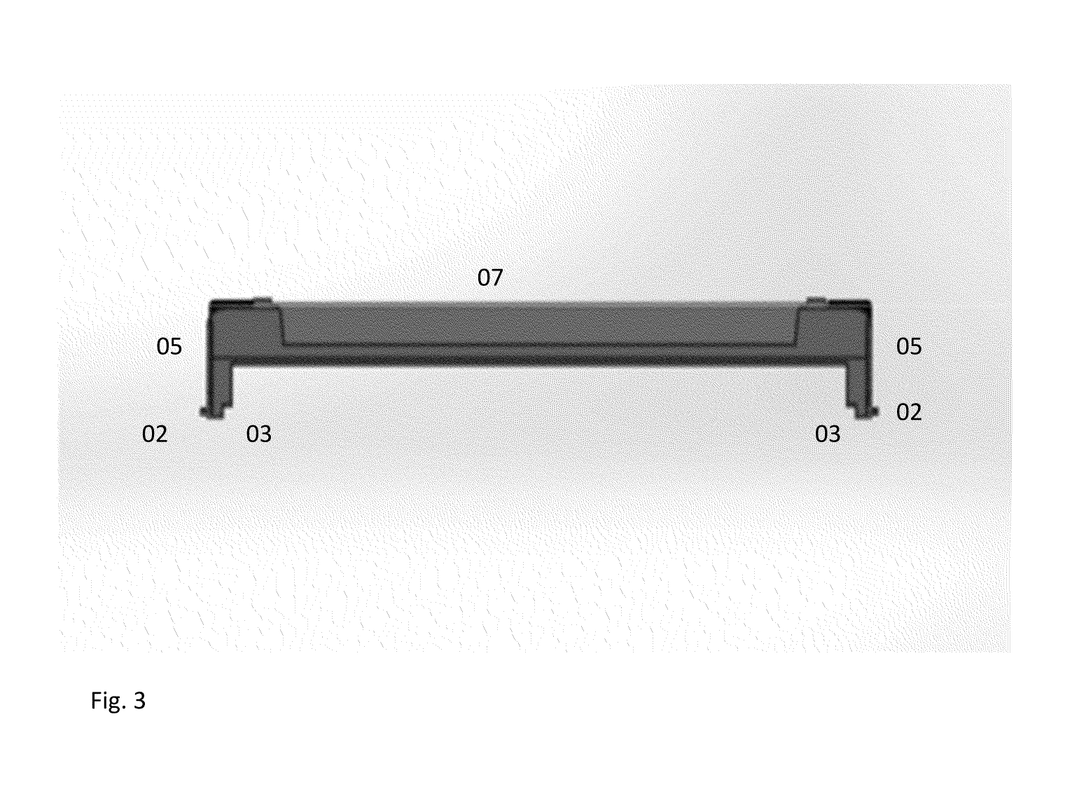

### FIG. 3: Bottom View Light Bracket:

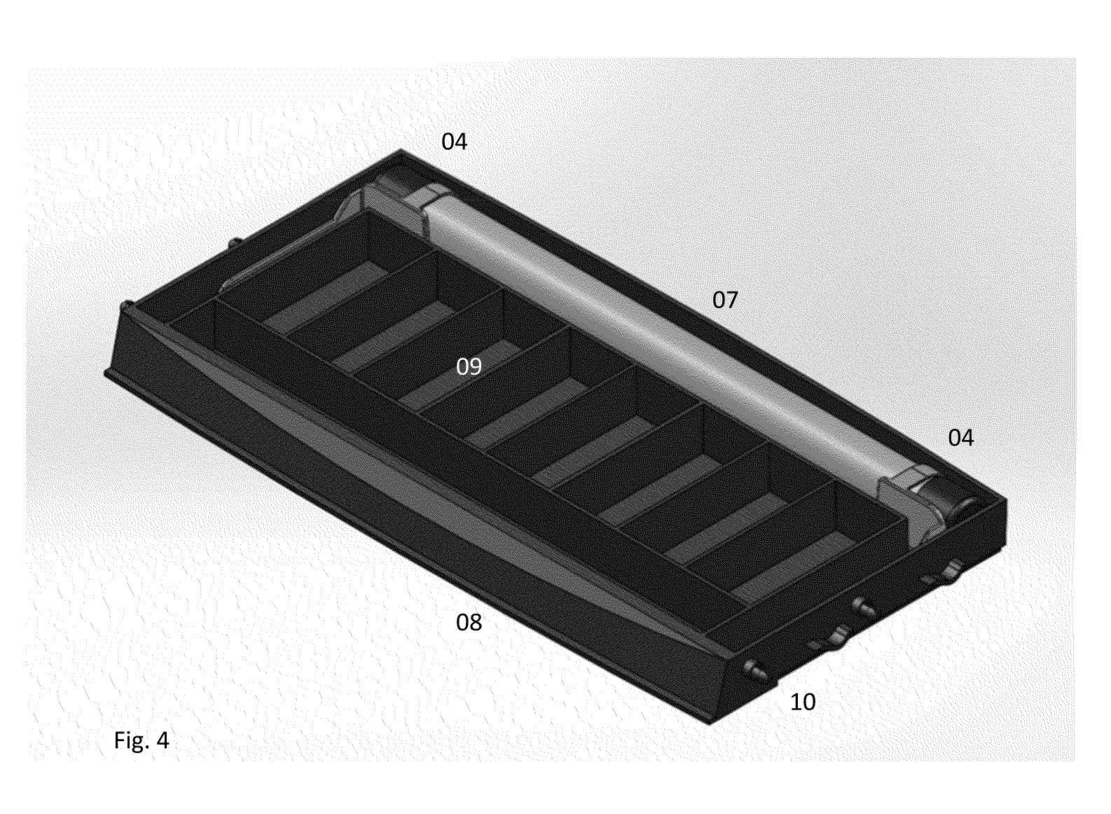

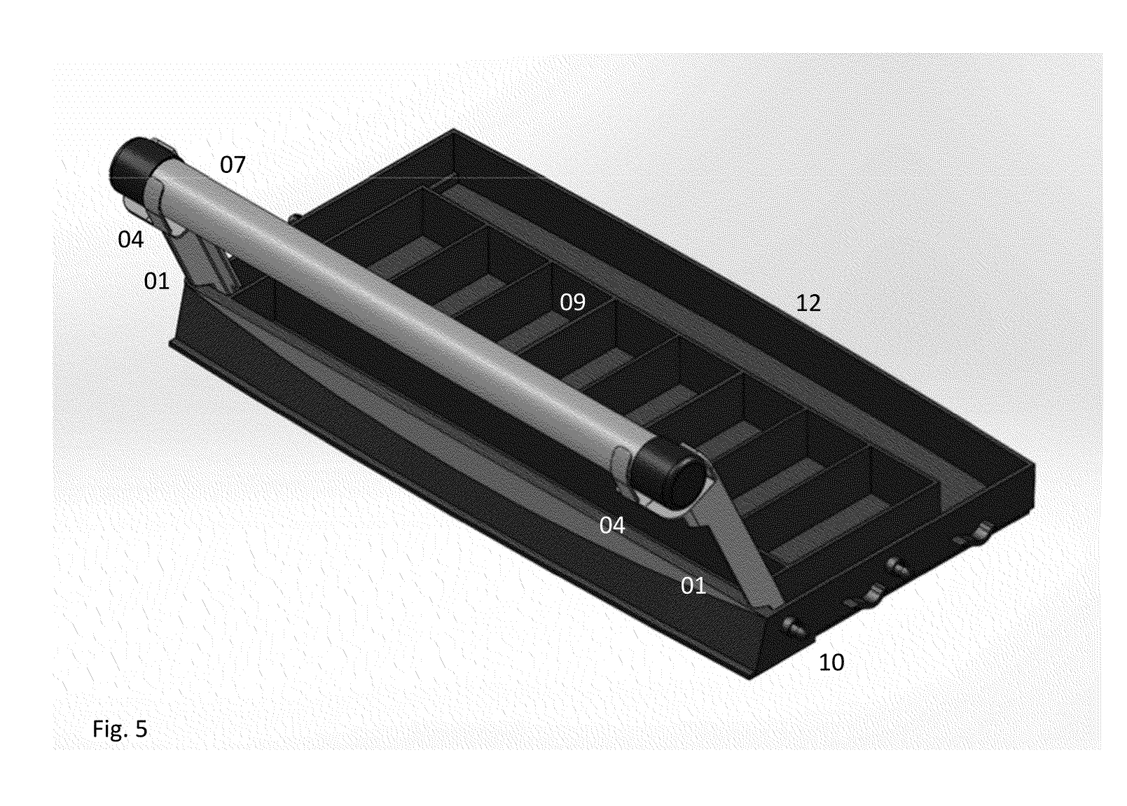

FIG. 4: Light Assembly Folded into Tray
08: Tray containing light bracket with tubular LED light folded within the tray.
09: Dividers for tackle/fishing equipment.
10: Plastic pegs which allow the tray to be snapped into the tackle box.
   FIG. 5: Light assembly in Upright Position
11: Light bracket folded out into its upright position containing the LED tubular light.
12: Cut out in tray for light hinge and tubular light.

1. A LED light that folds in and out of the tray of the tackle box that illuminates interior contents and surrounding areas around the tackle box

2. A light as claimed in claim 1, wherein the light is a self-contained LED light that can be removed from the tackle box to be used as a flashlight

3. A light as claimed in claim 1, wherein the light can be removed from the tackle box to be used as an underwater flashlight/fish light.

4. A light as claimed in claim 1, further comprising a set of hinges (that house the light) that can be removed from the tackle box to allow for extra storage space consumed by the hinge.

5. A glow in the dark tackle box.
